(19) United States
(12) Patent Application Publication
(10) Pub. No.: US 2016/0057457 A1
(43) Pub. Date: Feb. 25, 2016

(54) LIVE VIDEO BROADCASTING MOBILE APPLICATION FOR SOCIAL SHARING

(71) Applicants: JASON CLEMENTS, SANTA MONICA, CA (US); TEODROS GESSESSE, SANTA MONICA, CA (US); DARSHAN SEDANI, SANTA MONICA, CA (US); JERRY KLEIN, SANTA MONICA, CA (US)

(72) Inventors: JASON CLEMENTS, SANTA MONICA, CA (US); TEODROS GESSESSE, SANTA MONICA, CA (US); DARSHAN SEDANI, SANTA MONICA, CA (US); JERRY KLEIN, SANTA MONICA, CA (US)

(73) Assignee: LiveFromMe, Santa Monica, CA (US)

(21) Appl. No.: 14/821,519

(22) Filed: Aug. 7, 2015

Related U.S. Application Data
(60) Provisional application No. 62/041,487, filed on Aug. 25, 2014.

(51) Int. Cl. H04N 21/2187; H04N 21/4788; H04N 21/6405; H04N 21/488; H04N 21/4223

(52) U.S. Cl. CPC H04N 21/2187; H04N 21/4882; H04N 21/4223; H04N 21/6405; H04N 21/4788

(57) ABSTRACT

An approach for creation of a live video broadcasting mobile application for social sharing of digital streamed video data focused on providing the individual broadcaster with a quality of service normally provided to professional live broadcasting networks that senses the type of environment a user is currently using and provides all the features including global reach, unlimited viewer scaling, viewing control, viewer notification, high quality video delivery, and features that provide payout to viewers based on advertising revenue.

### PRIOR APPLICATIONS

This application claims priority of U.S. Provisional Patent Application Ser. No. 62/041,487 filed on Aug. 25, 2014, entitled “LIVE VIDEO BROADCASTING MOBILE APPLICATION FOR SOCIAL SHARING,” and is incorporated in its entirety in this application by this reference.

### FIELD OF THE INVENTION

This application relates to sharing video and more particular to sharing live video via social media.

### BACKGROUND

Using current applications, if somebody wants to share a moment with the world, that moment is typically recorded and then shared with others as recorded video with tools like YouTube or via one-to-one video conference tools like Face time, Skype etc. There are very few live video-streaming applications and they suffer from multiple problems: 1) Require users to have knowledge of video streaming and therefore configure the application correctly to stream; 2) Require that the user set up additional infrastructure to achieve distribution and scaling (such as setting up servers, publishing points and viewing players); 3) Throttle the quality of the video stream to a low quality video therefore making it a negative user experience; 4) Require that all broadcasts are public and therefore denying the user control over who watches their video; 5) Limit the distribution of the video to the an application therefore denying users on other devices the capability to view the video; 6) Limit the length of broadcast to a few minutes due to a lack of sufficient scalable infrastructure behind the applications; 7) Alienate a group of viewers due to video stream protocol supported; 8) Create a price barrier by charging a high price for the application.

What is needed in the art is an approach for consumer-to-consumer mobile based social live video streaming which can broadcast a video to an unlimited audience that overcomes the problems of known approaches.

### SUMMARY

In accordance with one embodiment of the disclosure, an approach for True consumer-to-consumer mobile based social live video streaming which can broadcast a video to an unlimited audience does in a simple application LiveFromMe (“LFM”) is provided. The LFM approach provides the individual broadcaster (user) with a quality of service normally provided to professional live broadcasting networks. A LFM application may intelligently senses the type of environment a user is currently using and provides all the features including global reach, unlimited viewer scaling, viewing control, viewer notification, high quality video delivery, and features that provide payout to viewers based on pay per view (PPV) and advertising revenue.

The above described features and advantages, as well as others, will become more readily apparent to those of ordinary skill in the art by reference to the following detailed description and accompanying drawings. While it is desirable to provide consumer-to-consumer mobile based social live video streaming which can broadcast a video to an unlimited audience, the teachings disclosed herein also extend to those embodiments which fall within the scope of the appended claims, regardless of whether they accomplish one or more of the above-mentioned advantages.

### BRIEF DESCRIPTION OF THE DRAWINGS

FIG. 1 is an exemplary diagram of the LiveFromMe (LFM) system in accordance with an example implementation of the invention;

FIG. 2 is an exemplary workflow diagram of the LFM system of FIG. 1 in accordance with an example implementation of the invention;

FIG. 3 is an exemplary workflow diagram of the performer workflow diagram portion of FIG. 2 in accordance with an example implementation of the invention;

FIG. 4 is an exemplary workflow diagram of the broadcaster portion of FIG. 2 in accordance with an example implementation of the invention; and

FIG. 5 is a network diagram of the LFM system of FIG. 1 in accordance with and example implementation of the invention.

### DESCRIPTION

An example embodiment of a utility vault having a power supply and heater to monitor and maintain a temperature is described.

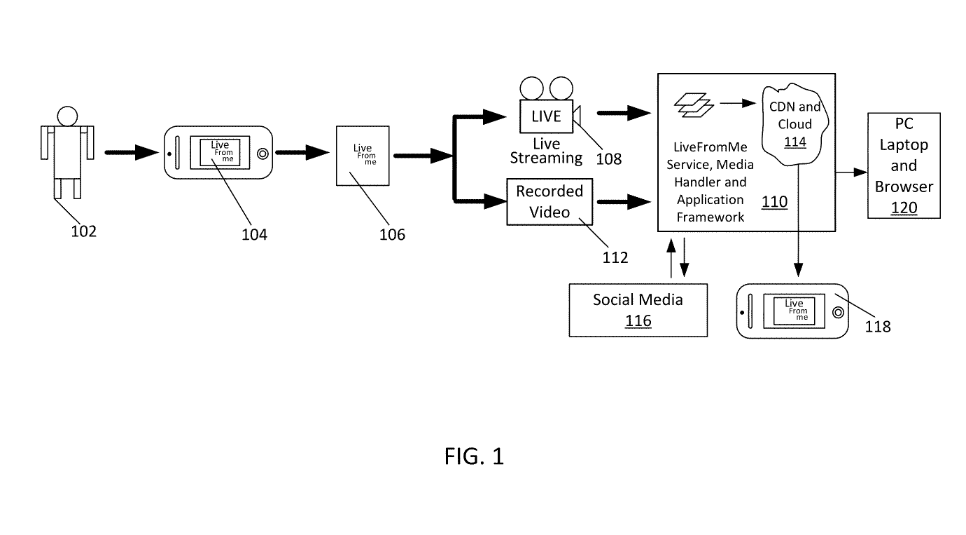

In FIG. 1, an exemplary diagram of the LiveFromMe (LFM) system 100 is depicted in accordance with an example implementation of the invention. A user 102 having a smart device 104, such as a smartphone, tablet, laptop computer, desktop computer, or similar device, may activate a LFM application 106. The LFM application 106 is a collection of machine readable instructions that enable a video input device (such as a camera) to be activated and format the data stream of video (live stream) 108 for transmission to the LFM Service Media Handler and Application Framework (LFMSMHAF) 110. The LFM application 106 may also format the data stream of video for recording 112. In other implementations, the recording may occur and be saved at the LFMSMHAF 110. The LFMSMHAF 110 may be part of a content delivery network (CDN) that may includes a server that resides in the cloud 114 is coupled to the internet, cellular, or wireless network to communicate with the smart device 104 and other servers (social media servers 116), other applications on other smart devices 118, and PCs and browser enabled devices 120.

Once a user 102 activates the LFM application 106 on a smart device 104, with a single button press (one-click) a streaming video broadcast may be created. A data stream of video is passed via a communication path being established between the smart device 106 and the LFMSMHAF 110. The bandwidth may be dynamically adjusted to assure the video quality of the data stream of video. The type of video engine accessed by the LFM application 106 may also be dynamically changed and/or adjusted. Users wishing to receive the broadcast may be contacted via communication between the LFMSMHAF 110 and social media servers 116 associated with potential recipients. In other implementations, recipients may be identified or further identified by geography or content preferences that may exist in their social media's profile or information contained in (or accessed by) a browser like FIREFOX, INTERNET EXPLORE, AND/OR CHROME to name but a few. Further, push notification may be employed to notify potential recipients of a live video. In yet other implementations, the LFMSMHAF 110 may embedded video search engine optimization feature in the data associated with the data stream of video to enable enhanced search and location of videos, intelligent push notification to users based on geography or content type, aggregated, live video switching involving multiple broadcasters, and syndicated live video feed to online entities.

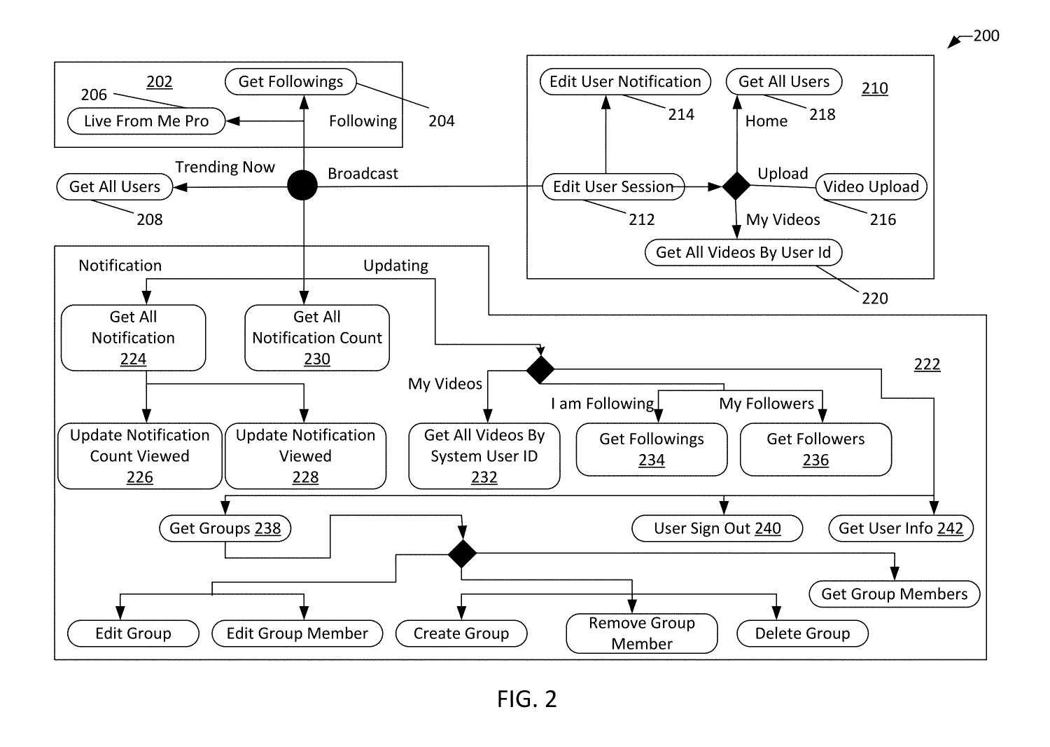

Turning to FIG. 2, an exemplary workflow diagram 200 of the LFM system 100 of FIG. 1 in accordance with an example implementation of the invention is depicted. A user may have a following 202 that requires the person to build up and get followers 204 who are notified of LFM performances 206. The followers 204 may be stored in a database accessible by the LFMSMHAF 110 of FIG. 1. In other implementations the database may be stored in memory or in semi-permanent memory, such as a hard drive in the LFMSMHAF 110. Whenever the user initiates a live performance, the LFMSMHAF 110 may access the database and notify the followers. Such notifications may be via social media with alerts or messages being sent to potential viewers' social media accounts located on the social media servers 116, FIG. 1. Notifications of trending live performances, may be sent to all users via a trending now message 208.

In order to broadcast a live video, a user may configure a plurality of broadcast parameters of preferences (accessed via one click broadcasting). Broadcast parameters 210 may enable a user to set parameters values per session or semi-permanently via a graphical user interface (GUI) located on the smart device 104. In other implementations, the broadcast parameters 210 may be set via a communication path with the LFMSMHAF 110. A user may also edit user notification parameters 214 that enable filtering of notifications that are sent regarding a live broadcast. A user may also upload recorded videos or stored recorded live performances via the video upload GUI 216. Get all users GUI 218 may be used to identify all broadcast users who are broadcasting live. The get all videos by user's id GUI 220 provides the ability to identify all the videos that have been recorded by a user.

Additional GUI are available to aid in reviewing and updating notifications 224, notification count viewed counter 226, notification viewed 228, and get all notification count 230. Get all videos associated by a system user id GUI 232 enables all videos by a specific system user ID to be identified. Users that are being followed may be identified with get followings GUI 234 and similarly followers identified with get followers GUI 236. Additional GUI may be employed for management of group associations and profiles 238, 240 and 242.

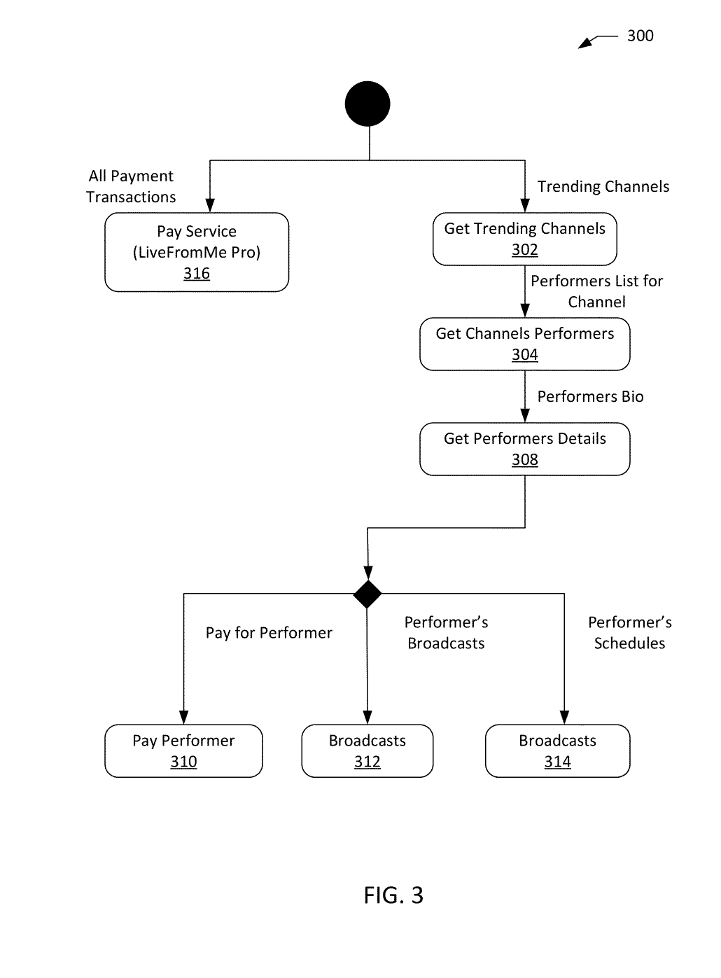

In FIG. 3, an exemplary workflow diagram of the performer workflow diagram 300 portion of FIG. 2 in accordance with an example implementation of the invention is depicted. Trending channels list 302 may be presented to a user. A list of performances 304 for the each of the trending broadcasts/channels in the trending channels list 302 may be presented to a user. A user may further drill down and obtain performer details 308, such as a performance biography of works. The user may then be presented with the opportunity to purchase a performance 310 (if the broadcast is configured to be purchased), watch a broadcast 312 if free, or review a schedule of a performer's performances 314. Purchased performances 310 may be a prime or other special purchase, for example subscription purchase and/or enrollment purchases, and purchased via a pay service GUI 316. The pay service may be and an external service or and internal service or optionally both. Examples of external pay service include PAYPAL and internal pay service include LIVEFROMME PRO).

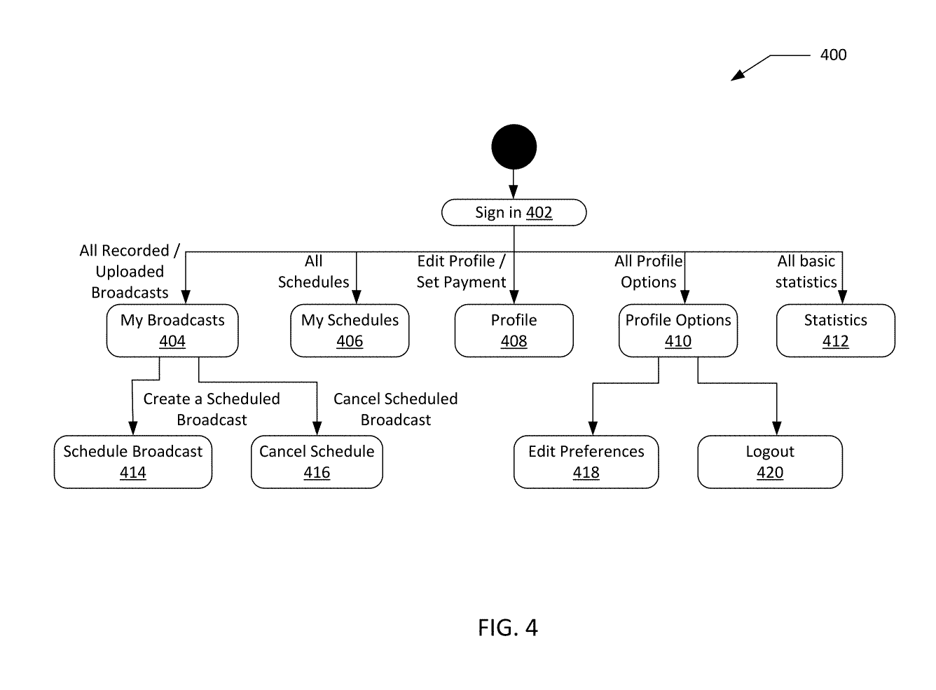

Turning to FIG. 4, an exemplary workflow diagram 400 of the broadcaster portion of FIG. 2 in accordance with an example implementation of the invention is depicted. A user may sign into the LFM system 100 via signin GUI 402. The signing in process may include authentication of a user's identity and the status of the user's account (locked out, outstanding balance, lack of use, to many wrong login attempts, etc. . . . Once signed in a user may see their uploaded or previously recorded performances 404, schedule of performances 406, user profile 408, profile options 410, account statistics 412. The broadcasts GUI 404 may further enable a user to schedule a broadcast 414 or cancel an already scheduled broadcast 416. The profile options 410 may further enable the preferences to be edited 418 or the user to logout 420.

Using the workflows of FIGS. 1-4, the following features may be implemented in the LFM application with support from the LFMSMHAF 110. These features include:

Free download-able applications (iOS and Android): LFM is a free downloadable application geared for iOS and Android platforms. The application can be used on smartphones, tablets and other compatible devices meeting the minimum specifications provided.

Intelligent bandwidth measurement prior to initiating broadcast: Since mobile devices can be at varying locations, the LFM application has incorporated intelligent network sensing capabilities that automatically configure a user's device for a successful streaming session.

Intelligent encoding profile selection based on device and bandwidth: Due to the variety of broadcasting and viewing devices, LFM uses an intelligent profile selection that picks that right video profile for both broadcasting and viewing. Since devices use different types of video protocols, it is important to select the correct protocol for a device to enable video viewing on a variety of browsers, operating systems and video players

On-device software encoding: LFM uses a best-in-class live video-encoding algorithm outputting standard video stream protocols. Our encoder is optimized for mobile devices to minimize processor and battery usage.

Fault tolerant stream push to cloud: The LFM application uses persistent push capability if and when any network or connection errors are detected in reaching out to the LFM delivery network.

LFM Geo Tracking of broadcast source: LFM delivery network identifies closest media delivery server data center from its delivery network based on viewer's geographical location for optimum and scalable live stream delivery.

Local device archiving process for live broadcasts: Users can select if they want to record a stream on their local broadcasting device. The recording can be for a single event or setup as a default for all broadcasts for offline viewing and accessibility.

Social media single sign-on for Facebook, Twitter and WhatApp: Understanding that most users do not wish to create multiple login identities on a variety of platforms, LFM users sign-in with their existing online identities.

Invite friends from existing social media accounts: Utilizing a user's existing investment in time and organization, LFM lets users send notifications and invitations to users that are in their existing social networks including Facebook, Twitter and WhatsApp.

User selectable viewer restriction broadcasting using public/private switch: Understanding that users might not want all broadcasts to by public, LFM provides a private viewing feature that enables a stream to be viewed by invitees only. All notifications may be turned off during a private stream with the exception of invitees that were sent notifications by the broadcaster.

Cloud archiving of streamed content (DVR): Providing additional user experience enhancement, all broadcasts can be optionally recorded in the cloud to provide instant replay capability. Viewers that missed a live event may then be able to watch the recorded version.

Adaptive streaming support: Network conditions on carrier networks as well as Wi-Fi availability may vary based on a user's broadcasting location. In some cases, even the time of the day may affect a network's available bandwidth for a live video broadcast. LFM uses intelligent sensing to change the broadcast upload bandwidth based on current conditions.

Adaptive stream viewing support: Uses intelligent bandwidth sensing on viewer's playback devices for optimum viewing experience.

Automated posting of live video into Facebook: Extends a user's ability to broadcast a live video feed into their Facebook timeline to engage with friends, family or the public in real-time using an environment they are used to for looking at latest updates.

Automated posting of live video into Twitter feed: Broadcast a live video feed link to your Twitter feed to get the word out beyond words.

Library of videos that were broadcast by user: Let your viewers scan through a library of your past broadcasts.

Select to follow a broadcaster: If you like a broadcaster select follow to be notified when the broadcaster goes live or uploads a video.

Show number of fans following a broadcaster: Measure the popularity of a broadcaster by seeing how many followers the broadcaster has gathered.

Notify followers of a broadcast: Broadcasters can optionally notify all their followers whenever they go live.

Notify users based on geography: If a viewer has subscribed to any live views within certain geography, the viewer is notified whenever a live broadcast is started in the specific geography the viewer has selected.

Notify users based on content keywords a user has subscribed to: If a viewer has subscribed to live views based on keywords, the viewer is notified whenever a live broadcast is initiated using the specific key words.

Search live broadcasts based on keywords: Viewers can search for live or on demand broadcasts based on keywords entered by broadcaster.

Search live broadcasts based on geography: Viewers can search for live events within defined geography. For example, a viewer can search to find live broadcasts in Seattle, Wash. only.

Display active global broadcasts visually: A viewer can select from all active broadcasts using a global visual map of the world or a breakdown by state or province or even further down by city.

Push to send a broadcast to a live video feed: The premium version of LFM may enable broadcasters to provide live video feeds to syndicated network news sites from news hot spots, sports locations or any other area where a network is available for live broadcasting.

Discover devices to use as a live video source switch: A premium version of LFM may enable a user to aggregate live feeds from several mobile devices and use the app to switch and broadcast a video from the live feed acquired by the other mobile devices. This is the first mobile-based live video switching tool.

Promote videos using video SEO: Makes videos readily discoverable.

View videos on LFM web portal: Viewers can also search and find both live and on demand videos from a web based portal accessible on standard web browsers.

View videos on Roku portal: Viewers can watch videos from LFMs Roku channel.

View videos on AppleTV portal: Viewers can watch videos from LFM's AppleTV channel.

View videos on Samsung Smart TV: Viewers can watch videos from LFM's Samsung Internet TV channel.

Integrated geo-targeted video advertising: LFM may display in video advertising and is tightly integrated with AdMob for video advertising delivery. The advertising may be displayed on the entire LFM eco-system of viewing devices including mobile phones, tablets, PCs and set-top-boxes and utilizes geo location information to enable better and relevant targeting to viewers.

Integrated geo targeted banner ad advertising: LFM displays banner ads in video as part of a revenue generation feature. The advertising may be displayed on the entire

LFM eco-system of viewing devices including mobile phones, tablets, and PCs and utilizes geo location information to enable better and relevant targeting to viewers.

Share video via email: Users can share their live broadcast link via email.

Localization support: The LFM application is localized to support major languages for ease of use.

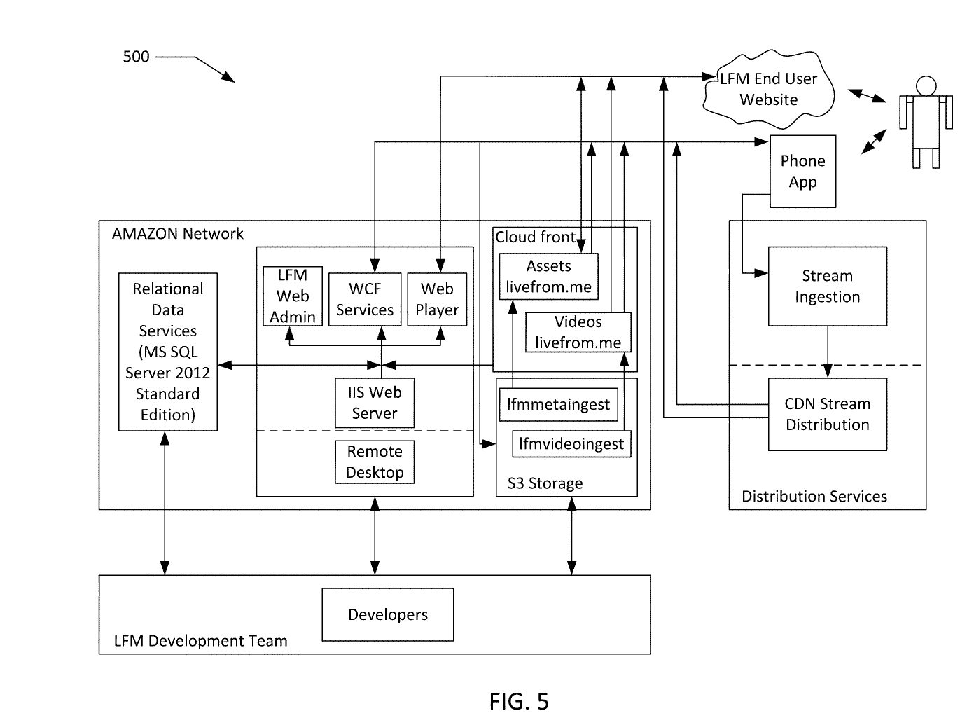

In FIG. 5, a network diagram 500 of the LFM system 100 of FIG. 1 in accordance with and example implementation of the invention is depicted. The network diagram 500 shows the different communication paths that may be utilized with using the LFM system 100 of FIG. 1.

Further, the LFM system 100 may employ on-device software encoding where the smart device 106 encodes the video data stream at the device (i.e. device capturing the image encodes the video data stream). As presented the LFM system 100 may be implemented such that the following features are available to the user:

| | |
|---|---|
| 1 | On-device software encoding |
| 2 | Fault tolerant stream push to cloud |
| 3 | Notify followers of a broadcast |
| 4 | Share video via email |
| 5 | Local device archiving process for live broadcasts |
| 6 | Social media single sign-on for Facebook |
| 7 | Invite friends from existing social media accounts |
| 8 | Geo Tracking of broadcast source |
| 9 | User selectable viewer restriction broadcasting using public/private |
| | switch |
| 10 | Cloud archiving of streamed content (DVR) |
| 11 | Adaptive streaming support |
| 12 | Adaptive stream viewing support |
| 13 | Library of videos that were broadcast by user |
| 14 | Select to follow a broadcaster |
| 15 | Show number of fans following a broadcaster |

Additionally, the following features may also be implemented using the LFM system 100:

| | | |
|---|---|---|
| 1 | Live meta data | LFM application auto extracts thumbnails from |
| | creation (auto | the live video to ensure that the most |
| | thumbnails from live video) | relevant thumbnails are displayed to the user. |
| | | This helps the viewer easily recognize core |
| | | content of the video |
| 2 | Cross social media | Share your recorded broadcasts over social |
| | integration | media platforms like Facebook, Twitter & |
| | | WhatsApp directly from the app itself |
| 3 | Group network for | Users can create a private group if they want to |
| | private video | share their live broadcasts with targeted |
| | syndication | audience opposed to public broadcast. User can create |
| | | multiple groups |
| 4 | Ability for users to | Users are able to manage their network of |
| | create personalized | Followers & Following users |
| | following and | |
| | followers network | |
| 5 | Professional video | Broadcasters are able to apply the professional |
| | capture features | touch to their live video broadcasting sessions |
| | (zoom, in focus videos) | using features likes digital zoom and auto focus |
| 6 | International standard | Broadcast the recorded moments using |
| | format of video aspect | standard 16:9 video capturing format supported |
| | ratio support on | Full-HD, non-HD & widescreen devices |
| | mobile (16:9) | |
| 7 | Dedicated mobile | Each user receives a dedicated mobile video |
| | social video account | account. Using this, the user is able to manage |
| | per user (live and on- | various activities like managing the recorded |
| | demand) | broadcasts, managing the profile, setting up the |
| | | customized preferences for better broadcasting |
| | | experience and managing the Followers, |
| | | Following & User Groups |
| 8 | Active content | All the broadcasted videos are listed based on |
| | trending work flow | the predefined trending algorithm. Latest and |
| | | most popular content may be listed considering |
| | | various factors like active live videos, popularity, |
| | | number of likes and broadcaster's account |
| | | activity |
| 9 | Live interactive | Broadcasters & Viewers may be able to get |
| | overlays on player | information of the video, video interactive |
| | | features and other respective video related |
| | | features via overlays on playback video player |
| 10 | C2C mobile Platform | User may be able to monetize their content to |
| | for digital asset micro- | generate the revenue by setting up custom |
| | payment system | prices for the same |
| 11 | Multi-lingual support | LFM application will have support for major |
| | for on-video live | languages for ease of use. This ability may also |
| | interaction | be extended to chat sessions enabling users |
| | | choice of their preferred language |
| 12 | Auto video profile | Network conditions on carrier networks as well |
| | selection based on | as Wi-Fi availability varies based on the user's |
| | bandwidth availability | broadcasting location. LFM uses intelligent |
| | | bandwidth detection to change the video profile |
| | | based on the available bandwidth at the |
| | | location to enable optimum video profile |
| 13 | Cross live video | Extends the user's ability to broadcast video |
| | streaming platform | feed from LFM application to other video |
| | integration | streaming platforms like YouTube, UStream, etc. |
| | | This enables users to reach out to a wider |
| | | audience through a popular video sharing |
| | | networks |
| 14 | Global micro payment | Along with the current in-app payment |
| | support | mechanism through iTunes, support would also |
| | | be extended to payments via Google Play and |
| | | other universal payment gateways |
| 15 | Extension to RTMP live | LFM application supports RTMP enabled |
| | cameras (drones, | camera and devices inclusive but not limited to |
| | wearables) | Drones, Wearables, etc. |
| 16 | Extendable SDK | Users may use the LFM development kit to |
| | | create their own customized white-label |
| | | solution for mobile live streaming eco-system |
| 17 | Content relevance | Users may be presented with content with |
| | based on geo-location | geographical relevance |
| 18 | Industry specific video | This allows the broadcasters to customize their |
| | overlays (weather, | videos with specific overlays based on content |
| | sports, etc.) | genre |

It will be understood, and is appreciated by persons skilled in the art, that one or more processes, sub-processes, or process steps described in connection with FIG. 5 may be performed by hardware and/or software (machine readable instructions). If the approach is performed by software, the software may reside in software memory (not shown) in a suitable electronic processing component or system such as one or more of the functional components or modules schematically depicted in the figures.

The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any tangible means that may contain or store the program for use by or in connection with the instruction execution system, apparatus, or device. The tangible computer readable medium may selectively be, for example, but is not limited to, an electronic, magnetic, optical, electromagnetic, infrared, or semiconductor system, apparatus or device. More specific examples, but nonetheless a non-exhaustive list, of tangible computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper (punch cards or punch tape) or another suitable medium upon which the instructions may be electronically captured, then compiled, interpreted or otherwise processed in a suitable manner if necessary, and stored in a computer memory.

The foregoing detailed description of one or more embodiments of the approach for electric vault cover has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

1. A live from me system, comprising:
a broadcast server;
a smart device having a processor and a video camera; and
an application run by the processor on the smart device that enables the video camera to capture video images and streamed digital video data associated with the video image to the broadcast server, where the broadcast server notifies a predetermined group of potential viewers of the streamed digital video data when the streamed digital video data is active.
